(19) United States
(12) Patent Application Publication
(10) Pub. No.: US 2016/0049845 A1
(43) Pub. Date: Feb. 18, 2016

(54) MAGNETIC ROTOR SHAFT MODULE AND A ROTOR ASSEMBLY INCORPORATING THE SAME

(71) Applicant: ZiLift Holdings, Limited, Aberdeen (GB)

(72) Inventors: David John Gove, Aberdeen (GB); David Brian Payne, Milltimber (GB); Kenneth John Sears, Aberdeen (GB); Jamie Cochran, Inverurie (GB)

(21) Appl. No.: 14/457,161

(22) Filed: Aug. 12, 2014

(51) Int. Cl. H02K 7/00; H02K 1/28; H02K 3/00; H02K 1/27

(52) U.S. Cl. CPC H02K 7/003; H02K 1/278; H02K 1/28; H02K 3/00

(57) ABSTRACT

A rotor shaft includes at least two rotor modules each having a body. Each rotor module has a first longitudinal end including a first torque transmitting feature and a second longitudinal end including a second torque transmitting feature. The rotor module body has a plurality of flats formed on a surface thereof. A magnet is mounted on one or more flat in each of the at least two rotor modules. A sleeve is fitted over the magnets to retain the magnets on the flats.

### BACKGROUND

This disclosure relates generally to the field of rotors for rotating machines such as motors and pumps. More specifically, the disclosure relates to structures for and methods for making rotors for such machines wherein sequential circumferential offset is required along the longitudinal axis of the rotor.

In the construction of electrical, electromagnetic, and magnetic rotating machines, permanent magnets may be mounted on a rotor shaft. The rotor shaft typically includes machined flat surfaces on the rotor exterior (“flats”) for mounting of magnets and machined surfaces for mounting of journal bearings and thrust bearings at selected longitudinal positions along the rotor shaft. It is important that the rotor shaft and all the features formed on the shaft are straight and concentric to a high degree of accuracy, particularly if the shaft will be used in a machine that may run at high rotational speeds. For some machines requiring magnets to be affixed to the exterior thereof, it is desirable to have “skew” in the orientation of the magnet poles by progressively mounting the magnets (which individually are substantially shorter than the length of the rotor shaft) along the rotor shaft rotationally by a small amount. Magnet skew can improve some aspects of machine performance, such as ease of starting in the case of electrical machines and reduction of cogging torque.

One known method of manufacturing a rotor shaft includes forming all the features of the shaft, such as the magnet mounting flats and bearing surfaces, as a unitary structure, i.e., from one piece of rotor shaft material. A significant amount of material has to be removed to create the magnet mounting flats, and this machining can introduce distortion to the shaft, for example, by releasing stresses inherent in the base material of the shaft. After the features are formed, the magnets are mounted on the flats. Then, the magnets must be accurately machined, usually by grinding, to a finished size, followed by fitting a sleeve over the magnets. In some cases, the shaft can be very slender, for example, having a length of 660 mm and a diameter of 32 mm, such that the shaft distorts under the loads imposed by the action of machining the magnets. For such slender shafts, it is difficult to achieve the necessary dimensional accuracy, even when additional supports are used during the machining.

Manufacture of conventional rotor shafts is further complicated by the different machining needs for the magnets and bearing surfaces. Permanent magnets require special machining techniques, including the handling of magnetic debris, which can be damaging to machine tools. All the foregoing complications add cost and risk to the manufacturing process and can result in a high scrap rate of expensive components.

### BRIEF DESCRIPTION OF THE DRAWINGS

FIG. 1 shows an example of a section of bar stock used in manufacture of a magnetic rotor shaft module according to one illustrative embodiment.

FIG. 2 shows a center bore formed in the bar stock of FIG. 1.

FIG. 3A shows holes formed at the ends of the bar stock of FIG. 2.

FIG. 3B is an end view of FIG. 3A.

FIG. 4A shows the bar stock of FIG. 2 with machined flats on an exterior surface thereof.

FIG. 4B is an end view of FIG. 4A.

FIG. 5A shows magnets mounted in the flats of FIG. 4A.

FIG. 5B is an end view of FIG. 5A.

FIG. 6A shows a sleeve fitted over the magnets of FIG. 5A.

FIG. 6B is a partial cross-section of FIG. 6A.

FIG. 7A shows a rotor including magnetic rotor shaft modules.

FIG. 7B is a cross-section of FIG. 7A.

FIG. 8 shows an overlapping sleeve arrangement between adjoining magnetic rotor shaft modules.

FIG. 9 shows an assembled rotor with a skewed magnetic profile.

FIG. 10A shows a motor assembly including a rotor according to one illustrative embodiment.

FIG. 10B is a cross-section of FIG. 10A along line 10B-10B.

FIG. 11 shows one rotor end stub for a rotor assembly.

FIG. 12 shows an opposed rotor end stub for a rotor assembly to that shown in FIG. 11.

FIG. 13 shows a rotor assembly for use in a machine requiring intermediate bearings according to one illustrative embodiment.

FIG. 14A is a detail view of section 14A of FIG. 13.

FIG. 14B is a detail view of section 14B of FIG. 13.

FIG. 15A shows a recessed spigot for use in connecting rotor sections according to one illustrative embodiment.

FIG. 15B shows a protruding spigot configured to mate with the recessed spigot of FIG. 15A.

FIG. 16A shows a recessed spigot with flats according to another illustrative embodiment.

FIG. 16B shows a protruding spigot with mating flats for the recessed spigot of FIG. 16A.

FIG. 17A shows a recessed spigot according to another illustrative embodiment.

FIG. 17B shows a protruding spigot with a mating keyway for the recessed spigot of FIG. 17A.

FIG. 18A shows a recessed spigot including splines according to another illustrative embodiment.

FIG. 18B shows a protruding spigot with mating splines for the recessed spigot of FIG. 18A.

### DETAILED DESCRIPTION

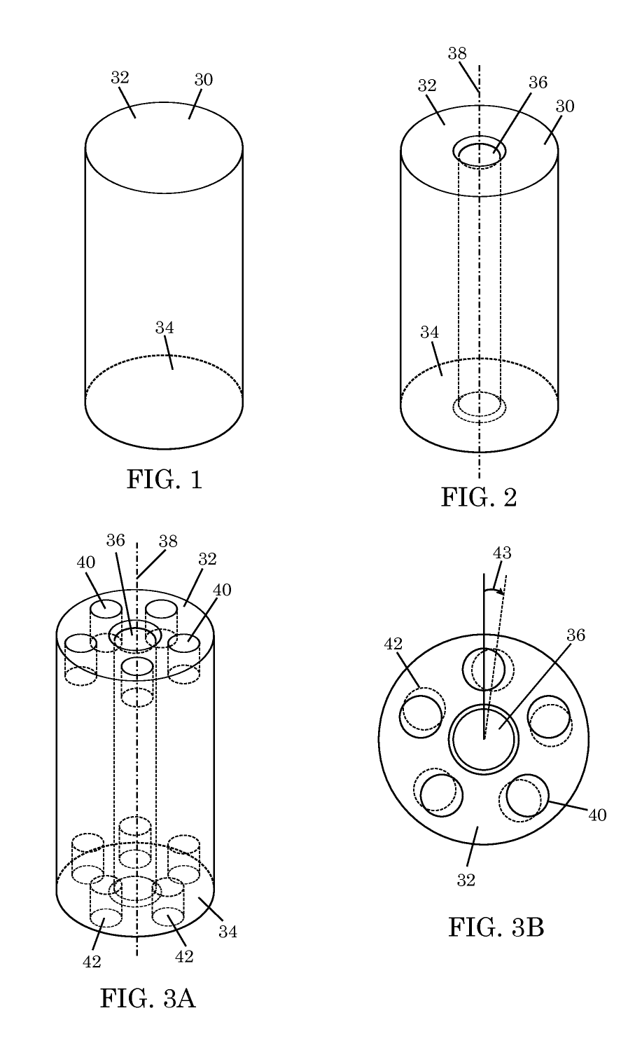

In one example embodiment according to the present disclosure, a method for making a magnetic rotor shaft module for use in construction of a rotor, includes starting with bar stock (“bar”) made of a selected material. In the present example, the material may be a machinable material, for example and without limitation, steel, other metals and machinable types of plastic. FIG. 1 shows an example bar 30. The bar 30 may have any desired cross-sectional shape. However, to minimize machining steps and reduce material waste during machining, it may be convenient to provide the bar 30 with a round cross-section. In one embodiment, the bar 30 may have a low length to diameter ratio, e.g., in a range of about 1 to 10 as opposed to being slender. This is to reduce the possibility of buckling of the bar 30 under compressive machining loads. The bar 30 has first and second longitudinal ends 32, 34 where connection and torque transmitting features will be located. For purposes of the present description only and not to limit the scope of the disclosure, the first longitudinal end 32 may be the end where male connection features will be located and may be referred to as the male connector end. The second longitudinal end 34 may be the end where female connection features will be located and may be referred to as the female connector end. The connection features may be or include torque transmitting features. Although the present example is described in terms of forming features in the bar 30 by machining, it is also possible to form features in the bar 30 to be described further below by sintering or casting. Thus, the features may be considered as “formed” in the bar 30 rather than only made by machining

In FIG. 2, a center bore 36 may be formed in the bar 30. The center bore 36 extends from the male connector end 32 to the female connector end 34 and may lie along a longitudinal axis 38 of the bar 30. Drilling of the center bore 36 can be initiated from both connector ends 32, 34 of the bar 30 to ensure accurate positioning of the bore 36 at the longitudinal axis 38 of the bar 30. The center bore 36 may provide a datum for subsequent machining operations. Machining of the center bore 36, as well as other machining operations (if machining is used) on the bar 30 that will be described below, may be accomplished using well known computerized numerically controlled (CNC) machining techniques.

In FIG. 3A, a set of holes 40 is formed in the bar 30 at the male connector end 32. The holes 40 may be formed substantially straight and parallel to the longitudinal axis 38 in one embodiment. The holes 40 may circumscribe the center bore 36 near the male connector end 32. Similarly, a set of holes 42 may be formed in the bar 30 at the female connector end 32. The holes 42 may be straight and parallel to the longitudinal axis 38 in one embodiment. The holes 42 may circumscribe the center bore 36 near the female connector end 34. In one illustrative embodiment, as illustrated in FIG. 3A and more clearly in FIG. 3B, the set of holes 42 in the female connector end 34 is rotationally offset from the set of holes 40 in the male connector end 32 by a selected angle 43, which may be determined based on a desired skew in the magnetic profile of the assembled rotor, to be described further below. Rotational offset between the holes 40, 42 in the opposed longitudinal ends of the bar 30 will enable construction of a rotor with a desired skewed magnetic profile. In one embodiment, the selected angle 43 may be zero for implementations where zero skew is desirable. In implementations where skew between modules 10 is desired, the selected angle 43 may be any selected angle suitable for the needs of the particular implementation.

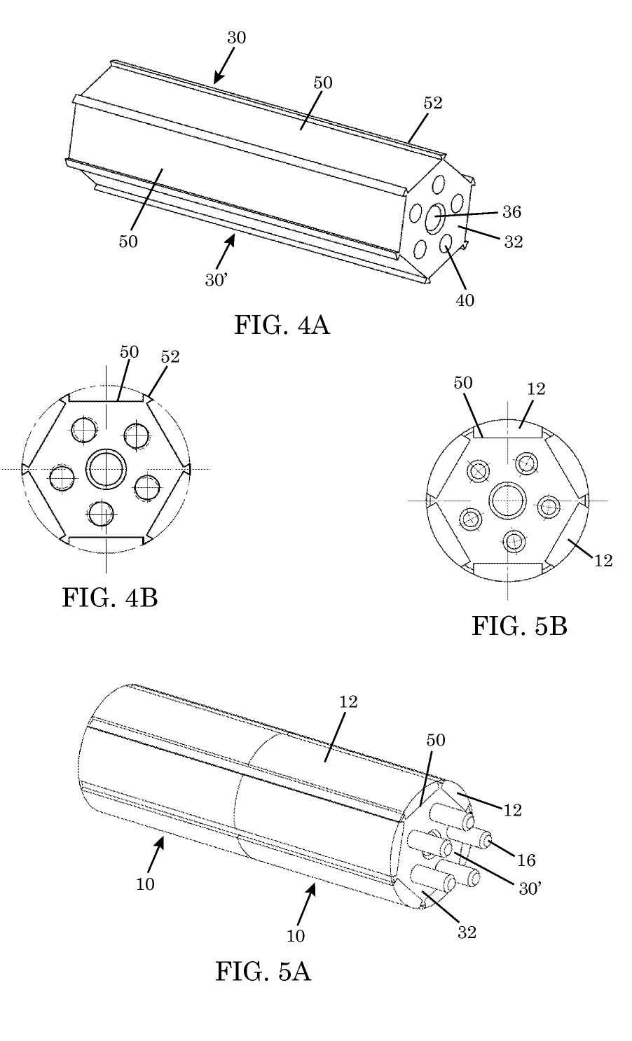

In FIGS. 4A and 4B, flats (or recesses with flat surfaces) 50 may be formed in the circumferential surface of the bar 30. The flats 50 may be arranged circumferentially along the bar 30, with bar material forming separating walls 52 between the flats 50. At this point, the formed bar 30 may be referred to as a rotor module 30′. FIGS. 5A and 5B show magnets 12 mounted on, or affixed to, the flats 50 of the rotor module 30′ to form a magnetic rotor module 10. Affixing may include bonding the magnets 12 to the flats 50 such as by adhesive or other known technique for bonding magnets to a surface. In other embodiments, the separating walls 52 may be shaped so as to retain the magnet 12 against its respective flat 50. In such embodiments, the magnets 50 may be inserted by sliding longitudinally into the space between the separating walls 52 along each flat. After mounting the magnets 12 on the flats 50, the magnets may be formed, for example, by grinding to a final size. The magnet forming may include shaping the magnets 12 such that the resulting assembly has a substantially uniform outer diameter, round cross-section and wherein the exterior surface of the magnets 12 so formed is substantially coaxial with the longitudinal axis (38 in FIG. 3A) of the rotor module 30′. The assembly shown in FIGS. 5A and 5B has six magnets 12 mounted to six flats 50 for a six-pole rotor. Any other number of flats and magnets may be formed in the rotor module within the scope of the present disclosure.

FIGS. 5A and 5B show pins 16 installed in the holes 40 (see FIG. 4A) in end view in FIG. 5B and in oblique view in FIG. 5A in the male connector end 32. For example, the pins 16 may be dowels (e.g., made from steel), and the holes 40 may be sized to provide an interference fit to the pins 16. Connection of a magnetic rotor module 10 to another magnetic rotor module 10 or rotor element to be explained further below may be made by inserting the pins 16 into the holes (42 in FIG. 3A) in the female connector end of an adjacent rotor module 30′. It should be noted that because the pins 16 are installed in the holes 40 in the male connector end 32, the set of pins 16 will also be rotationally offset from the set of holes 40 in the female connector end 34 of the adjacent rotor module 30′ as explained with reference to FIG. 3A. This may also be described as the male connection (or torque transmitting) feature, e.g., pins 16, being rotationally offset from the female connection (or torque transmitting) feature, e.g., holes 40. As will be shown later, other male and female connector features besides pins and holes may be used. An assembly of two adjacent rotor modules 30′ (or magnetic rotor modules 10) is shown in FIG. 5A.

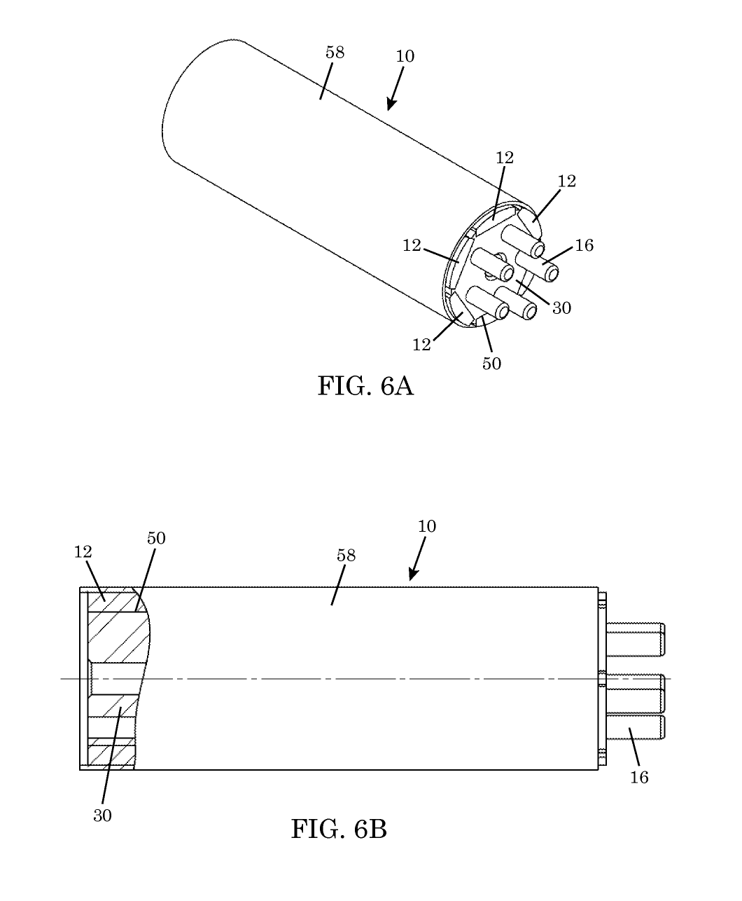

FIGS. 6A and 6B show a completely assembled pair of magnetic rotor modules at 10, with a sleeve 58 fitted over the magnets 12 to prevent the magnets from separating from the flats 50. The sleeve 58 may be very thin to avoid diminishing the electromagnetic performance of the machine in which the rotor is used. This thinness may make it difficult to install the sleeve 58 directly over the magnets 12 without damaging the sleeve 58. A practical method to fit such a very thin sleeve over the magnets 12 may include providing a sleeve with an inner bore that is finished to the correct size to fit over the magnets 12, e.g., with an interference fit but initially having a relatively thick wall. Such a sleeve may be provided as one sleeve for the entire rotor assembly or may be provided in multiple segments. The relatively thick-walled sleeve may be then fitted over the magnets 12, for example, by heating and shrink fitting or by bonding. Then, the outer diameter of the sleeve 58, whether as a unitary structure or in segments may be formed to a final external diameter. The sleeve 58 may be made, for example, from a non-magnetic metal such as monel, stainless steel or alloys sold under the trademark INCONEL, which is a registered trademark of Huntington Alloys Corp., Huntington, W. Va. The sleeve 58 may also be formed from other materials, such as thermoplastic, thermoset plastic and fiber reinforced plastic using any suitable type of fiber such as glass, polymer and/or carbon fiber and mixtures thereof. If the sleeve 58 is made from a non-magnetic metal, the final formed thickness thereof and the electrical conductivity of the metal may be selected to minimize induced eddy current power losses.

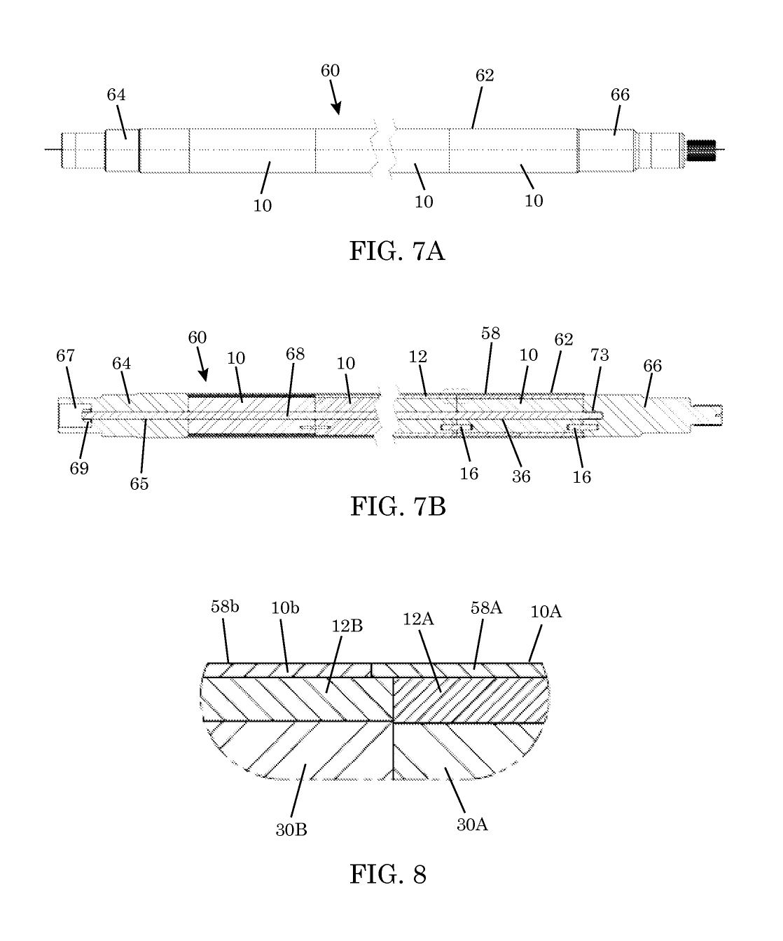

FIG. 7A shows an assembled modular rotor 60 having a rotor shaft 62, made from one or more rotor modules 10, and rotor end stubs 64, 66. In one non-limiting example, a rotor shaft may have a total length of 560 mm and may include five rotor modules 10, each being about 112 mm long. The rotor modules 10 in the example of FIG. 7A are arranged end-to-end to form the rotor shaft 62, and the rotor end stubs 64, 66 may be affixed at the ends of the rotor shaft 62. The assembled modular rotor 60 is shown in sectional view in FIG. 7B. In the example shown in FIG. 7B, pins 16 at the end of one rotor component are received in holes (40 in FIG. 4A) at the end of an adjacent rotor module or end stub in order to locate the rotor components relative to each other and to assemble the rotor 60 as explained with reference to FIGS. 5A and 6B. The rotor modules 10 and end stubs 64, 66 may be retained longitudinally by any form of tensioning member. In the present example embodiment, the tensioning member may include a stretch bolt 68 extending through the center of the rotor components (i.e. the center bores 36 in FIG. 4A). In one example, the stretch bolt 68 passes through a bore 65 in the upper rotor end stub 64 and the center bores 36 in the magnetic rotor modules 10. The stretch bolt 68 is then screwed into a threaded hole 73 in the lower rotor end stub 66. The rotor end stub shown at 64 may include a recess 67, which accommodates a nut 69 placed on the stretch bolt 68 and may provides clearance for a wrench or similar tool to tighten the nut 69 on the stretch bolt 68 to hold the components together in longitudinal compression. Any implementation of tensioning member known in the art that holds the rotor components together longitudinally may be used in accordance with the scope of the present disclosure.

In one embodiment, the stretch bolt 68 is tightened sufficiently such that the rotor modules 10 are held tightly compressed against each other, thereby ensuring that the rotor shaft assembly is stiff and resists bending distortion when rotating, for example, due to imbalanced loads or inertial effects. A practical method to tension the stretch bolt 68 is to tighten the nut 69 until all the rotor components are firmly seated against each other, and then to tighten the nut 69 a set number of rotations, which will cause the bolt 68 to stretch a certain amount according to the pitch of the nut thread. In a non-limiting example, the stretch bolt 68 is 10 mm in diameter and approximately 640 mm long, and the nut is tightened 2¾ turns after seating. This creates a stress of approximately 70% of the yield strength in the most slender part of the bolt 78.

For any set of adjoining magnetic rotor modules 10, the sleeve 58 on one of two adjoining rotor modules may be arranged to overlap the magnets 12 of the other adjoining rotor module in order to prevent ingress of fluid between the magnets 12 of the adjoining rotor modules. This overlapping arrangement is illustrated in FIG. 8 using magnetic rotor modules 10A, 10B as examples. In the junction between the adjoining rotor modules 10A, 10B, the sleeve 58A fitted over the magnets 12A of one rotor module 10A is extended beyond the longitudinal end of the rotor shaft body 30A. The extended sleeve 58A may overlap the magnets 12B of the adjoining rotor module 10B. This also means that the sleeve 58B fitted over the magnets 12B is set back relative to a longitudinal end of the rotor shaft body 30B in order to accommodate the overlapping sleeve 58A. The above described example overlapping arrangement may be used between any adjoining rotor shaft modules of a rotor assembly, such as rotor assembly 60 in FIG. 7B, to help prevent ingress of fluid between the magnets of the rotor shaft modules.

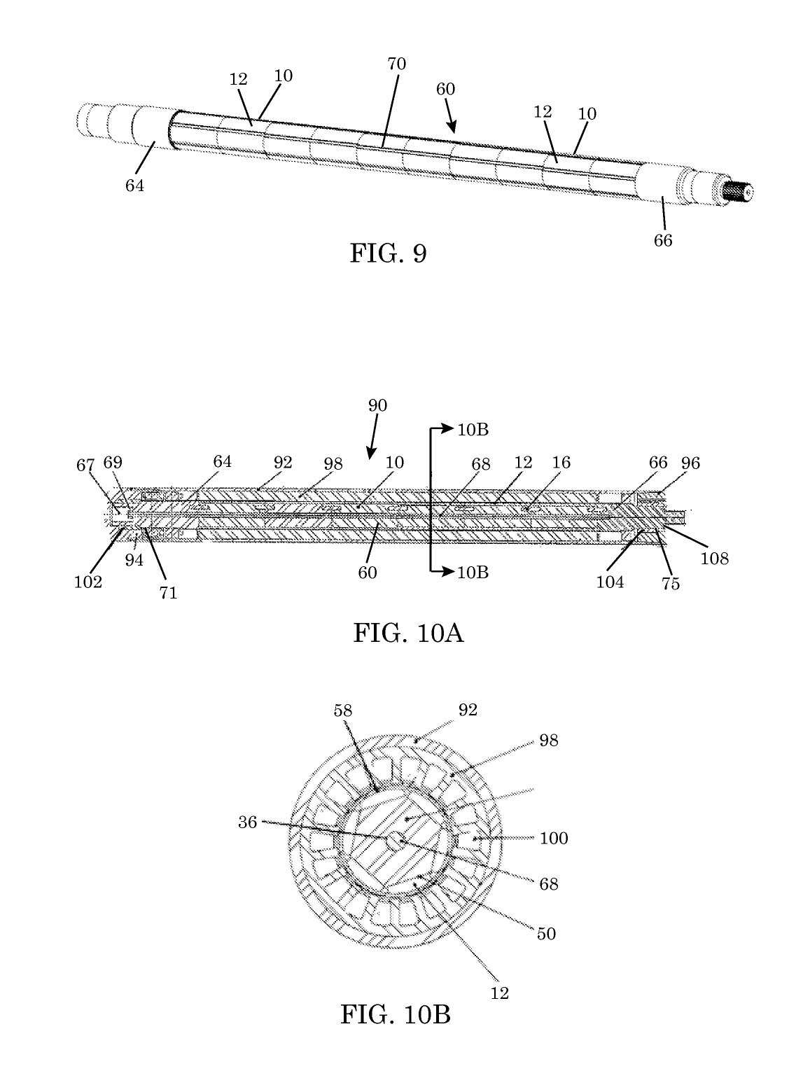

In one embodiment, as shown in FIG. 9, the magnetic rotor modules 10 form a skewed magnet profile 70. It should be noted that the sleeve(s) covering the magnets are not shown in FIG. 9 in order to allow the skewed magnet profile to be observable. The skewed magnet profile is provided by the rotational offset between the female connection features, e.g., holes, at the female connector end and the male connection features, e.g., holes/pins, at the male connector end of each magnetic rotor module 10 when each rotor module has rotationally offset male and female connection features as explained above with reference to FIG. 3A.

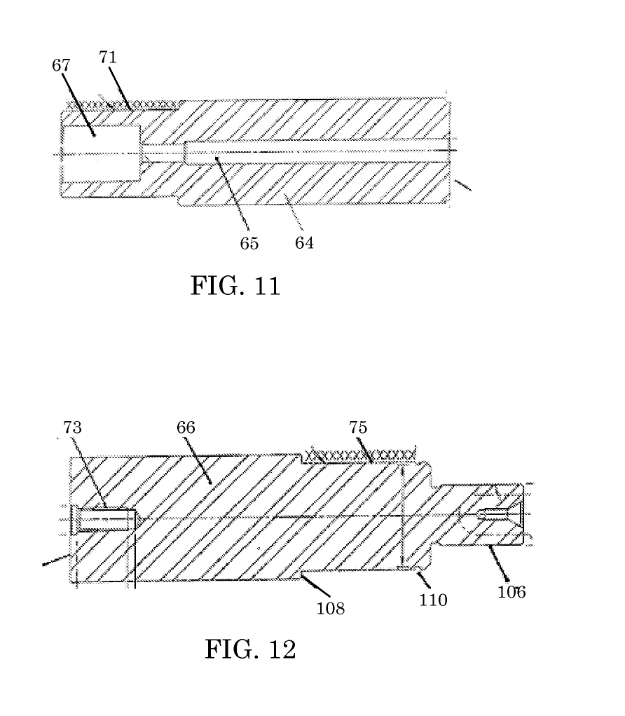

FIGS. 10A and 10B show an example motor assembly 90 in cut away side view and in end view, respectively, including example magnetic rotor modules as described above. The motor assembly 90 may include a motor housing 92. Laminations 98 may be fitted into the housing 92. The laminations 98 may be made with slots 100 (FIG. 10B) in which electrical winding coils (not shown) are fitted in a known manner to build a stator for an electric motor. The laminations and winding coils may be arranged, for example, to induce a rotating magnetic field by applying suitable alternating current to the windings, thus causing corresponding rotation of the rotor assembly 60. The example rotor assembly 60 is arranged within a bore defined by the laminations 98. The upper rotor end stub 64 of the rotor assembly 60 may be supported in an end connector 94 attached to an upper end of the motor housing 92. This support may include, for example, fitting a journal 71 or other bearing surface (shown more clearly in FIG. 11) of the upper rotor end stub 64 into a bearing 102 at the upper end connector 94. The lower rotor end stub 66 of the rotor assembly 60 is supported in end connector 96 attached to a lower end of the motor housing 92. This support may include, for example, fitting a journal 75 (shown more clearly in FIG. 12) or other bearing surface of the lower rotor end stub 66 into a bearing 104 at the lower end connector 96. The upper and lower end connectors 94, 96 may be attached to the housing 92 by screw threads.

The lower rotor end stub 66 may be provided with a connecting shaft (see 106 in FIG. 12) to transfer rotational energy from the rotor 60 to a machine which the rotor 60 is driving. The connecting shaft may be made, e.g., with splines, a keyway, or any other known structure for connecting torque transmitting shafts. The lower rotor end stub 66 may also be provided with a thrust face 108 and a location groove (see 110 in FIG. 12) for retaining a ring, which together allow axial location of the rotor assembly 60 within the motor housing 92 to be provided by the bearing 102. Although the foregoing example embodiments are described in terms of journal bearings, any other form of rotary bearing, including, without limitation, roller bearings and ball bearings may be used in other examples.

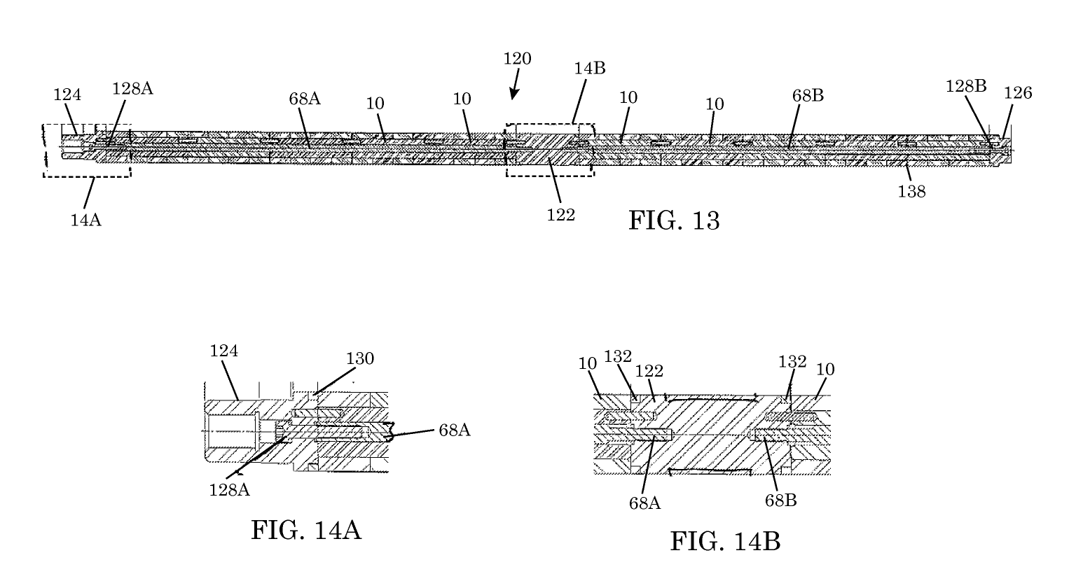

FIG. 13 shows a rotor assembly 120 adapted for use in a motor or other electromagnetic machine where the rotor requires one or more intermediate bearings to support the rotor assembly 120. In the rotor assembly 120, an intermediate bearing element 122 may be disposed between two rotor modules 10. The intermediate bearing element 122 provides a surface or body on which a bearing (as explained above, any known type of rotary bearing) may be mounted or incorporated. The bearing itself is not shown in detail for the sake of clarity. Typically, the intermediate bearing element 122 will not have any magnets assembled on it, but a shaft structure according to the present disclosure is not so limited. A possible advantage of the structure shown in FIG. 13 is that the intermediate bearing element 122 may be made from materials that are particularly well suited to use in bearings, or the intermediate bearing element 122 may be given specific surface treatments to make it suitable for use as a bearing or to enable a bearing to be mounted on it. In some embodiments, a plurality of such intermediate bearing elements 122 may be included between magnetic rotor modules 10, as needed for any particular length of application of the rotor 60.

Stretch bolts 68A, 68B may be used to retain the magnetic modules 10, intermediate bearing element 122, and rotor end stubs 124, 126. In some embodiments, the stretch bolts 68A, 68B may be threaded into one end to the intermediate bearing element 122. Bolts 128A, 128B may threadedly connect with internal threads in the stretch bolts 68A, 68B or the intermediate bearing elements 122 and then may be used to apply tension to the stretch bolts 68A, 68B. This method of tensioning the stretch bolts 68A, 68B with the threaded bolts 128A, 128B is another possible longitudinal tensioning structure than the previously described use of a nut on the stretch bolt. It may also be possible to include internal threads in one end stub (e.g., either 124 or 126) so that one stretch bolt 68A may be used without a separate nut to hold the rotor shaft components together longitudinally.

A non-magnetic and electrically insulating ring may be included at the ends of the magnet containing modules to control magnetic field in this area. FIG. 14A shows an example where a non-magnetic and electrically insulating ring 130 is installed at the face of the rotor end stub 124 adjoining the magnetic containing rotor module 10. FIG. 14B shows another example where non- magnetic and electrically insulating rings 132 may be installed at the ends of the bearing element 122 adjoining rotor modules 10. It should be noted that the non-magnetic and electrically insulating ring may be used with the rotor assembly 60 described in FIGS. 7A and 7B, having only longitudinal endmost bearings and not just with the rotor assembly incorporating intermediate bearings.

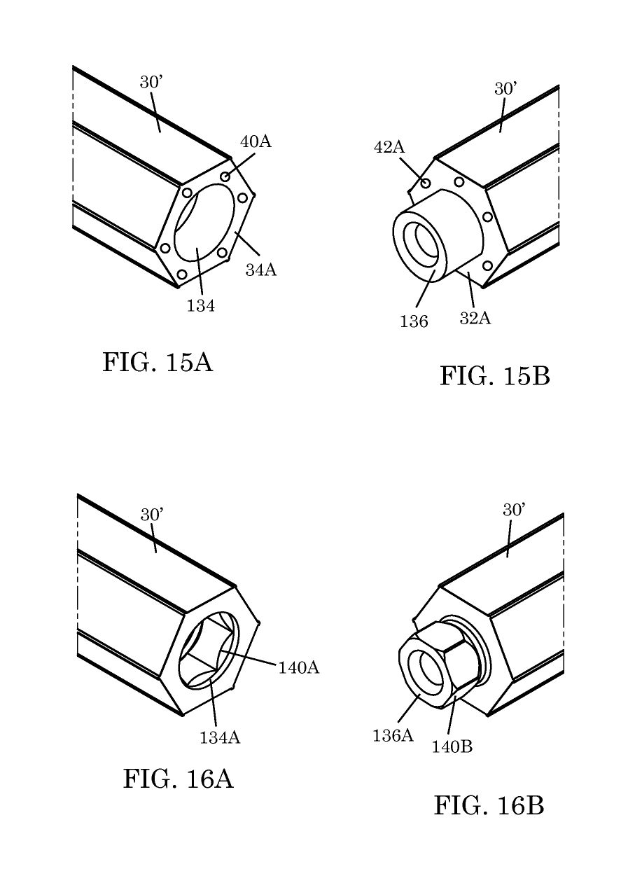

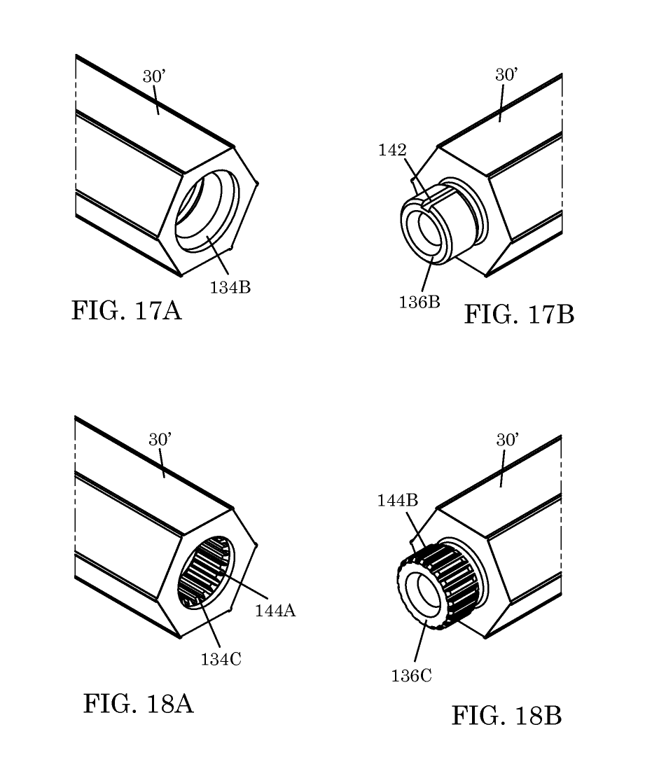

FIGS. 15A and 15B show a recessed spigot 134 (i.e., a cylindrical or other shaped recess formed in the longitudinal end 34A of a module or bearing section) and a corresponding protruding spigot 136 (e.g., in the shape of an annular cylindrical extension from the longitudinal end 32A of the adjacent rotor module or bearing section) that may be used between the ends of rotor modules, e.g., at the connection 138 in FIG. 13, to increase the dimensional accuracy between the rotor modules and/or bearing sections when they are assembled. Such concentric circular features can reliably be manufactured to a very high degree of accuracy precision. Pins (not shown) may be installed in the set of holes 40A in the connection end 34A of FIG. 15A or in the set of holes 42A in the connection end 32A of FIG. 15B, e.g., similar to what is shown at 16 in FIG. 5A. The recessed spigot 134 and the protruding spigot 136 may also be part of torque transmitting features and may include therein mating splines, flats or a keyway or key receptacle, respectively for a torque transmitting feature. FIG. 16A shows an example recessed spigot 134A with flats 140A, and FIG. 16B shows an example protruding spigot 136A including flats 140B adapted to mate with the flats 140A of the recessed spigot 134A of FIG. 16A. For each module, the flats on the recessed spigot on one end of the module may be rotationally offset to the flats on the protruding spigot on the other end of the module such that two or more modules having the flats can be connected together to achieve a skewed rotor magnetic profile. FIG. 17A shows an example recessed spigot 134B with a key (not visible), and FIG. 17B shows an example protruding spigot 136B with a keyway 142 adapted to receive the key in the recessed spigot 134B. Again, for each module, the key in the recessed spigot on one end of the module may be rotationally offset to the keyway in the protruding spigot on the other end of the module. FIG. 18A shows an example recessed spigot 134C with multiple splines 144A, and FIG. 18B shows an example protruding spigot 136C with multiple splines 144B for mating with corresponding splines 144A of the recessed spigot 144B. Rotational offset between splines on each module may be used to obtain a skewed rotor magnetic profile.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A rotor shaft, comprising:
at least two rotor modules each having a body, each rotor module having a first longitudinal end including a first torque transmitting feature and a second longitudinal end including a second torque transmitting feature, the rotor module body further having a plurality of flats formed on a surface thereof;
a magnet mounted on one or more flats in each of the at least two rotor modules; and
a sleeve fitted over the magnets to retain the magnets on the flats.

2. The rotor shaft of claim 1 wherein the first torque transmitting feature is rotationally offset with respect to the second torque transmitting feature about a longitudinal axis of the rotor module by a selected angle.

3. The rotor shaft of claim 1 wherein each flat comprises retainers formed on sides thereof for retaining the respective magnet therein.

4. The rotor shaft of claim 1, wherein each of the rotor modules further comprises a center bore aligned along a longitudinal axis thereof.

5. The rotor shaft of claim 1, wherein the sleeve is fitted over the magnets such that one end of the sleeve is extended beyond a distal end of one of the rotor module bodies.

6. The rotor shaft of claim 1, wherein the sleeve is fitted over the magnets such that one end of the sleeve is set back relative to a distal end of one of the rotor module bodies.

7. The rotor shaft of claim 1, wherein the rotor shaft body has a length to diameter ratio in a range of one to ten.

8. The rotor shaft of claim 1 wherein the first and second torque transmitting features comprise a plurality of holes formed in the respective one of the first and second longitudinal ends and a pin inserted into each of the plurality of holes.

9. The rotor shaft of claim 1 wherein the first and second torque transmitting features comprise mating splines.

10. The rotor shaft of claim 1 wherein the first torque transmitting feature comprises a keyway in a spigot and the second torque transmitting feature comprises a key inserted into a receptacle therefor.

11. A rotor assembly, comprising:
at least two rotor modules each having a body, each rotor module having a first longitudinal end including a first torque transmitting feature and a second longitudinal end including a second torque transmitting feature, the rotor module body further having a plurality of flats formed on a surface thereof;
a magnet mounted on one or more of the flats in each of the at least two rotor modules;
a sleeve fitted over the magnets to retain the magnets on the flats; and
at least one tensioning member for retaining the at least two rotor modules and a rotor end stub disposed on each of opposed longitudinal ends of the at least two rotor modules placed longitudinally adjacent each other together and in compression.

12. The rotor assembly of claim 11 wherein the first torque transmitting feature is rotationally offset with respect to the second torque transmitting feature about a longitudinal axis of the rotor module by a selected angle.

13. The rotor assembly of claim 11 wherein each flat comprises retainers on sides thereof for retaining the respective magnet therein.

14. The rotor assembly of claim 11, further comprising more than two rotor modules disposed adjacent to each other between the first and second rotor end stubs.

15. The rotor assembly of claim 11, wherein each of the rotor modules has a center bore, and wherein the at least one tensioning member extends through the center bores.

16. The rotor assembly of claim 11, further comprising at least one bearing element disposed between at least one pair of rotor modules.

17. The rotor assembly of claim 11, wherein a skewed magnetic profile is determined by the rotational offset of the first and second torque transmitting features in opposed longitudinal ends of each of the rotor modules.

18. The rotor assembly of claim 11, further comprising a non-magnetic and electrically insulating ring disposed adjacent to a longitudinal end of the at least one rotor module.

19. The rotor assembly of claim 11, wherein each of the rotor end stubs comprises a bearing surface.

20. The rotor assembly of claim 11, wherein one of the rotor end stubs comprises a connecting shaft.

21. The rotor assembly of claim 11, wherein one of the end stubs comprises a thrust face.

22. The rotor assembly of claim 11 further comprising a housing disposed externally to the rotor assembly, the housing having therein components to induce a rotating magnetic field to induce rotation of the rotor assembly.

23. The rotor assembly of claim 11 wherein the first and second torque transmitting features comprise a plurality of holes formed in the respective one of the first and second longitudinal ends and a pin inserted into each of the plurality of holes.

24. The rotor assembly of claim 11 wherein the first and second torque transmitting features comprise mating splines.

25. The rotor assembly of claim 11 wherein the first torque transmitting feature comprises a keyway in a spigot and the second torque transmitting feature comprises a key inserted into a receptacle therefor.
